(19) United States
(12) Patent Application Publication
(10) Pub. No.: US 2025/0336985 A1
(43) Pub. Date: Oct. 30, 2025

(54) METHOD FOR MANUFACTURING BIDIRECTIONAL PROTON CONDUCTIVE FUEL CELL USING MICROWAVE-BASED SINTERING AND BIDIRECTIONAL PROTON CONDUCTIVE FUEL CELL MANUFACTURED THEREBY

(71) Applicant: KOREA ADVANCED INSTITUTE OF SCIENCE AND TECHNOLOGY, Daejeon (KR)

(72) Inventors: Kang Taek LEE, Daejeon (KR); Se Eun OH, Daejeon (KR); Hyeong Geun KIM, Daejeon (KR); Dong Yeon KIM, Daejeon (KR)

(21) Appl. No.: 18/873,204

(22) PCT Filed: Oct. 8, 2024
(86) PCT No.: PCT/KR2024/015320

§ 371 Date: Dec. 9, 2024

(30) Foreign Application Priority Data
Oct. 27, 2023 (KR) 10-2023-0145917
Aug. 5, 2024 (KR) 10-2024-0103945

(51) Int. Cl. H01M 4/88; H01M 8/18

(52) U.S. Cl. CPC H01M 4/88; H01M 8/18

(57) ABSTRACT

According to an embodiment, by using a pellet capable of microwave absorption and heat dissipation, the temperature is increased to 900° C. or higher in a short period of time, and a vapor-phase sintering agent rapidly diffused from the pellet can accelerate the sintering of a PCEC. Specifically, the sintering temperature is reduced by 500° C. or higher compared to the existing process, and the time is also shortened from 300 minutes to 5 minutes, thereby resolving the cationic segregation phenomenon that occurs in the existing sintering process, and thus improving the performance of a PCEC.

### TECHNICAL FIELD

The present invention relates to a method for manufacturing a bidirectional proton conductive fuel cell using microwave-based sintering and a bidirectional proton conductive fuel cell manufactured thereby.

### BACKGROUND ART

As energy consumption continues to increase worldwide, the need to develop efficient and clean energy conversion and storage technologies is increasing.

Among them, hydrogen is considered a promising candidate for reducing carbon dioxide emissions and achieving carbon neutrality. Recently, among energy conversion and storage technologies using hydrogen as fuel, a bidirectional proton conductive fuel cell (PCEC) has been attracting attention. This is a next-generation energy conversion system that can convert hydrogen into electricity in a fuel cell mode and electricity into fuel in an electrolytic cell mode and operates with high efficiency.

Compared to the existing oxygen ion conduction-based solid oxide fuel cell (SOFC), the PCEC has the advantage of easy charge transfer with lower activation energy (0.4-0.6 eV) than oxygen because it uses protons with a small ion radius. Therefore, the PCEC can provide high energy conversion efficiency at lower temperatures (450-650° C.) than the existing solid oxide fuel cell, which is advantageous for the development of low-cost, high-efficiency systems.

However, there is a problem that the conventional PCEC manufacturing requires a long-term high-temperature sintering process of 1500° C. or more, which may immediately cause performance degradation factors. In order to suppress the occurrence of these performance degradation factors, it is necessary to develop a process that can reduce the sintering temperature and time.
(Patent Document 0001) US Registered U.S. Pat. No. 10,305,116

### DETAILED DESCRIPTION OF THE INVENTION

### Technical Problem

An aspect of the present invention is to provide a process capable of reducing the sintering temperature and time in order to replace the conventional long-term high-temperature sintering process of 1500° C. or more required for the production of a PCEC.

The aspect of the present invention is not limited to that mentioned above, and other aspects not mentioned will be clearly understood by those skilled in the art from the description below.

### Technical Solution

An embodiment of the present invention provides a method for manufacturing a bidirectional proton conductive fuel cell, including: a first step of manufacturing a fuel electrode support slurry, a fuel electrode functional layer slurry, and an electrolyte slurry; a second step of manufacturing a fuel electrode support tape, a fuel electrode functional layer tape, and an electrolyte tape by tape casting each of the slurries manufactured in the first step; a third step of sequentially laminating the fuel electrode support tape, the fuel electrode functional layer tape, and the electrolyte tape manufactured in the second step to form a laminated structure; a fourth step of sintering the laminated structure formed in the third step by heat-treating the same in two stages at different temperatures; a fifth step of forming an air electrode on the surface of the laminated structure sintered in the fourth step where the electrolyte tape is placed; and a sixth step of sintering the laminated structure in which the air electrode is formed in the fifth step, wherein the fourth step includes a first heat treatment and a second heat treatment performed at different temperatures, and the second heat treatment is performed by placing a pellet that improves the sintering degree of the laminated structure in a microwave sintering furnace and using the microwave sintering furnace.

In an embodiment of the present invention, the pellet may be a NiO—BaZr_{0.4}Ce_{0.4}Y_{0.1}Yb_{0.1}O_{3-δ} pellet.

In an embodiment of the present invention, the NiO—BaZr_{0.4}Ce_{0.4}Y_{0.1}Yb_{0.1}O_{3-δ} pellet may be manufactured by a manufacturing method including: mixing a NiO and BaZr_{0.4}Ce_{0.4}Y_{0.1}Yb_{0.1}O_{3-δ} powder; pelletizing the mixed powder; and microwave sintering the pelletized powder.

In an embodiment of the present invention, the second heat treatment may be performed at 900° C. to 1000° C. for 5 to 10 minutes.

In an embodiment of the present invention, the fuel electrode support slurry or fuel electrode functional layer slurry may include a NiO and BaZr_{0.4}Ce_{0.4}Y_{0.1}Yb_{0.1}O_{3-δ} composite.

In an embodiment of the present invention, the electrolyte slurry may include BaZr_{0.4}Ce_{0.4}Y_{0.1}Yb_{0.1}O_{3-δ}.

In an embodiment of the present invention, the third step may be performed by sequentially laminating the fuel electrode support tape, the fuel electrode functional layer tape, and the electrolyte tape, and compressing the sequentially laminated fuel electrode support tape, fuel electrode functional layer tape, and electrolyte tape at a temperature of 100° C. to 140° C.

In an embodiment of the present invention, the first heat treatment may be performed at 800° C. to 1,000° C. for 2 to 4 hours.

In an embodiment of the present invention, the sixth step may be performed at 800° C. to 900° C. for 2 to 5 minutes.

Another embodiment of the present invention provides a bidirectional proton conductive fuel cell manufactured according to the above-described method for manufacturing a bidirectional proton conductive fuel cell.

### Advantageous Effects

According to an embodiment of the present invention, by introducing a microwave-based sintering furnace instead of the existing convection heat transfer-based sintering furnace, a PCEC can be produced in a short period of time.

By using a pellet capable of microwave absorption and heat dissipation, the temperature can be raised to 900° C. or more in a short period of time, and a vapor-phase sintering agent rapidly diffused from the pellet can accelerate the sintering of a PCEC.

Specifically, the sintering temperature is reduced by 500° C. or higher compared to the existing process, and the time is also shortened from 300 minutes to 5 minutes, thereby resolving the cationic segregation phenomenon that occurs in the existing sintering process, and thus improving the performance of a PCEC.

The effects of the present invention are not limited to the effects described above, and should be understood to include all effects that are inferable from the configuration of the present invention described in the detailed description or claims of the present invention.

### BRIEF DESCRIPTION OF THE DRAWINGS

FIG. 1 is a time and temperature graph comparing a second heat treatment according to an embodiment of the present invention with a conventional sintering procedure.

FIG. 2 is an SEM image of an electrolyte surface microstructure according to the temperature of a support manufactured according to an embodiment of the present invention.

FIG. 3 is an SEM image of a microstructure of a unit cell manufactured using a support sintered at 980° C. according to an embodiment of the present invention.

FIG. 4 is an X-ray diffraction pattern of an electrolyte of a support manufactured at 980° C. and 1000° C. according to an embodiment of the present invention.

FIGS. 5A and 5B are each a graph showing the performance of a unit cell manufactured according to an embodiment of the present invention in a fuel cell (5A) or electrolytic cell (5B) mode.

FIG. 6 is a graph showing the result of a long-term stability evaluation of a unit cell manufactured according to an embodiment of the present invention in an electrolytic cell mode.

### MODE FOR CARRYING OUT THE INVENTION

Hereinafter, the present invention will be described with reference to the accompanying drawings. However, the present invention may be implemented in various different forms and, therefore, is not limited to the embodiments described herein. In order to clearly explain the present invention in the drawings, portions unrelated to the description are omitted, and similar portions are given similar reference numerals throughout the specification.

Throughout the specification, when a portion is said to be “connected (linked, contacted, combined)” with another portion, this includes not only a case of being “directly connected” but also a case of being “indirectly connected” with another member in between. In addition, when a portion is said to “include” a certain component, this does not mean that other components are excluded, but that other components may be added, unless specifically stated to the contrary.

The terms used herein are merely used to describe specific embodiments and are not intended to limit the present invention. Singular expressions include plural expressions unless the context clearly dictates otherwise. In this specification, it should be understood terms such as “include” or “have” are to designate the presence of features, numbers, steps, operations, components, parts, or combinations thereof described in the specification, but are not to exclude in advance the possibility of the presence or addition of one or more other features, numbers, steps, operations, components, parts, or combinations thereof.

Hereinafter, an electrolyte material for a solid oxide fuel cell, which is an embodiment of the present invention, will be described in detail.

In this specification, “BYN” means BaY₂NiO₅.

In this specification, “BZCYYb” means BaZr_{0.4}Ce_{0.4}Y_{0.1}Yb_{0.1}O_{3-δ}.

In this specification, “BSTC” means BaSc_{0.1}Ta_{0.1}Co_{0.8}O_{3-δ}.

A method for manufacturing a bidirectional proton conductive fuel cell according to an embodiment of the present invention will be described.

A method for manufacturing a bidirectional proton conductive fuel cell according to an embodiment of the present invention may include: a first step of manufacturing a fuel electrode support slurry, a fuel electrode functional layer slurry, and an electrolyte slurry; a second step of manufacturing a fuel electrode support tape, a fuel electrode functional layer tape, and an electrolyte tape by tape casting each of the slurries manufactured in the first step; a third step of sequentially laminating the fuel electrode support tape, the fuel electrode functional layer tape, and the electrolyte tape manufactured in the second step to form a laminated structure; a fourth step of sintering the laminated structure formed in the third step by heat-treating the same in two stages at different temperatures; a fifth step of forming an air electrode on the surface of the laminated structure sintered in the fourth step where the electrolyte tape is placed; and a sixth step of sintering the laminated structure in which the air electrode is formed in the fifth step, wherein the fourth step includes a first heat treatment and a second heat treatment performed at different temperatures, and the second heat treatment is performed by placing a pellet that improves the sintering degree of the laminated structure in a microwave sintering furnace and using the microwave sintering furnace.

The first step is a step of manufacturing a fuel electrode support slurry, a fuel electrode functional layer slurry, and an electrolyte slurry.

The first step may be performed using a Resonant Acoustic Mixer (RAM).

In an embodiment of the present invention, the first step mixes each of proton conductive ceramic powders, solvents, etc. constituting the fuel electrode support slurry, fuel electrode functional layer slurry, and electrolyte slurry using the RAM, and the fuel electrode support slurry, fuel electrode functional layer slurry, and electrolyte slurry may be manufactured.

The RAM is a scheme of mixing by dispersing or crushing particles of a mixture using the principle of acoustic resonance. More specifically, the mixture may be induced into an acoustic resonance state by utilizing a natural resonant acoustic frequency that may refine the particle size of the mixture, and at this time, acoustic energy including the resonant acoustic frequency is accumulated inside the particles of the mixture, and the particles are uniquely dispersed into a structure or surrounding medium.

The first step of the present invention manufactures a fuel electrode support slurry, fuel electrode functional layer slurry, and electrolyte slurry using the above-described principle, so that the degree of crushing and dispersion of large particles and aggregated particles generated in a normal mixing process may be increased and thus the quality of a slurry can be improved through uniform mixing.

In an embodiment of the present invention, the fuel electrode support slurry or fuel electrode functional layer slurry may include a NiO and BaZr_{0.4}Ce_{0.4}Y_{0.1}Yb_{0.1}O_{3-δ} composite.

In an embodiment of the present invention, the electrolyte slurry may include BaZr_{0.4}Ce_{0.4}Y_{0.1}Yb_{0.1}O_{3-δ}.

It is known that a BaCeO₃—BaZrO₃ solid mixture co-doped with yttrium and ytterbium exhibits relatively high proton conductivity in the medium-low temperature range. In the case of the BaCeO₃-based material, the proton conductivity is the highest and the sintering property is relatively excellent, but it exhibits weak phase stability in water vapor and carbon dioxide atmospheres, whereas, in the case of the BaZrO₃-based material, the phase stability is relatively excellent and the intragranular proton conductivity is excellent, but the sintering property is low and the grain boundary proton conductivity is significantly lower than that of the intragranular proton conductivity.

The NiO may be reduced to Ni by the fuel supplied after a cell is connected and may serve as an electron conductive material.

In a specific embodiment, the electrolyte slurry may further include at least one of a binder, a plasticizer, a dispersant, and a solvent as needed, and the binder, the plasticizer, the dispersant, and the solvent are not particularly limited, wherein conventional materials known in the relevant technical field may be used.

The second step is a step of manufacturing a fuel electrode support tape, a fuel electrode functional layer tape, and an electrolyte tape by tape casting each of the slurries manufactured in the first step.

In a specific embodiment, a process of manufacturing the fuel electrode support tape may be performed including a procedure of coating the fuel electrode support slurry on a release film using a doctor blade having a thickness of several hundred μm to 1,000 μm, drying the same, and then peeling off the release film.

At this time, the drying may be performed at 50° C. to 120° C. for 10 minutes or less, and the type of the release film is not particularly limited, wherein for example, a polyethylene (PET) carrier film coated with silicon (Si) may be used.

In an embodiment of the present invention, a process of manufacturing the fuel electrode functional layer tape may be performed including a procedure of coating the fuel electrode functional layer slurry on a release film using a film applicator having a thickness of several tens of μm, drying the same, and then peeling off the release film.

At this time, the drying may be performed at 50° C. to 120° C. for 10 minutes or less, and the type of the release film is not particularly limited, wherein for example, a polyethylene (PET) carrier film coated with silicon (Si) may be used.

In an embodiment of the present invention, a process of manufacturing the electrolyte tape may be performed including a procedure of coating the electrolyte slurry on a release film using a film applicator having a thickness of several tens of μm, drying the same, and then peeling off the release film.

At this time, the drying may be performed at 50° C. to 120° C. for 10 minutes or less, and the type of the release film is not particularly limited, wherein for example, a polyethylene (PET) carrier film coated with silicon (Si) may be used.

The third step is a step of sequentially laminating the fuel electrode support tape, fuel electrode functional layer tape, and electrolyte tape manufactured in the second step to form a laminated structure.

In an embodiment of the present invention, the third step may be performed by sequentially laminating the fuel electrode support tape, the fuel electrode functional layer tape, and the electrolyte tape, and compressing the sequentially laminated fuel electrode support tape, fuel electrode functional layer tape, and electrolyte tape at a temperature of 100° C. to 140° C.

In a specific embodiment, the third step may be performed using a lamination device, wherein the fuel electrode support tape, the fuel electrode functional layer tape, and the electrolyte tape, each cut to an appropriate size, for example, 8×8 cm², are sequentially laminated to form a laminated structure, which is then introduced into the lamination device and then compressed in four directions at 120° C., and the laminated structure produced in the above process may include a structure of a fuel electrode support/a fuel electrode functional layer/an electrolyte.

The fourth step is a step of sintering the laminated structure formed in the third step by heat-treating the same in two stages at different temperatures.

The fourth step may include a first heat treatment and a second heat treatment performed at different temperatures.

The first heat treatment corresponds to a pretreatment process for preventing combustion of organic substances included in the laminated structure, warping or cracking of ceramics, and may be performed at 800° C. to 1,000° C. for 2 to 4 hours.

The first heat treatment may be performed using a sintering furnace commonly used in the present technical field.

The second heat treatment may be performed by placing a pellet that improves the sintering degree of the laminated structure in a microwave sintering furnace and using the microwave sintering furnace.

A microwave sintering process has the advantage of minimizing deformation or destruction of a sintered body due to thermal shock because a temperature gradient inside a specimen is small because heat is generated in the specimen itself by microwaves.

In an embodiment of the present invention, the pellet may be a NiO—BaZr_{0.4}Ce_{0.4}Y_{0.1}Yb_{0.1}O_{3-δ} pellet.

The NiO—BaZr_{0.4}Ce_{0.4}Y_{0.1}Yb_{0.1}O_{3-δ} pellet may be manufactured by a manufacturing method including: mixing a NiO and BaZr_{0.4}Ce_{0.4}Y_{0.1}Yb_{0.1}O_{3-δ} powder; pelletizing the mixed powder; and microwave sintering the pelletized powder.

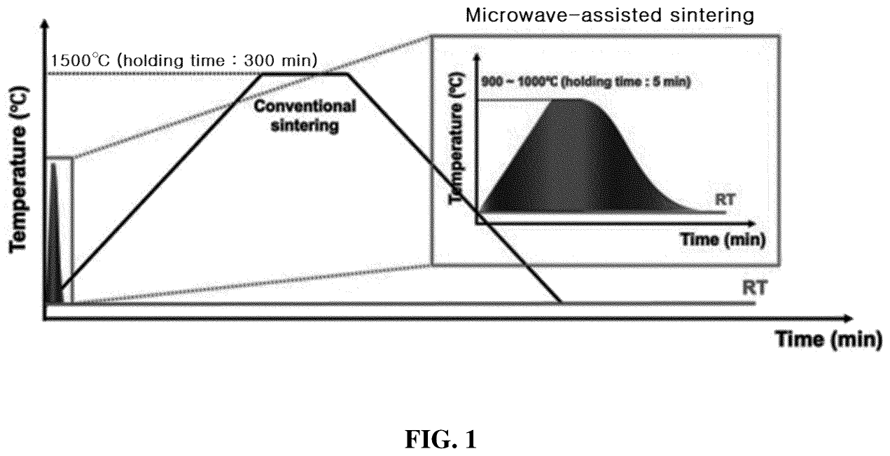

FIG. 1 is a time and temperature graph comparing a second heat treatment according to an embodiment of the present invention with a conventional sintering procedure. Referring to FIG. 1, it is possible to confirm that a pellet, which is the raw material of a vapor phase sintering agent that can improve the sintering degree of the laminated structure, is placed in the microwave sintering furnace, and thus, when microwaves are applied, the pellet absorbs microwaves and emit heat, the temperature rises to over 900° C. in a short period of time, and a vapor phase sintering agent that quickly diffuses from the pellet can accelerate the sintering of a PCEC. The above second heat treatment may be performed at 900° C. to 1000° C. for 5 to 10 minutes.

The fifth step is a step of forming an air electrode on the surface of the laminated structure sintered in the fourth step where the electrolyte tape is placed.

In an embodiment of the present invention, the air electrode may include, but is not limited to, an inorganic material having oxygen ion conductivity, for example, lanthanum strontium cobalt ferrite (LSCF), for example, LSCF2882(La_{0.2}Sr_{0.8}Co_{0.2}Fe_{0.8}O₃).

The sixth step is a step of sintering the laminated structure in which the air electrode is formed in the fifth step.

The sixth step may be performed at 800° C. to 900° C. for 2 to 5 minutes.

Hereinafter, a bidirectional proton conductive fuel cell according to another embodiment of the present invention will be described.

A bidirectional proton conductive fuel cell according to an embodiment of the present invention may be manufactured according to the above-described method for manufacturing a bidirectional proton conductive fuel cell.

### Embodiment

### 1.1 Material Synthesis

To produce BaY₂NiO₅ (BYN), which may be a vapor phase raw material, a NiO and BaZr_{0.4}Ce_{0.4}Y_{0.1}Yb_{0.1}O_{3-δ} (BZCYYb) powder was mixed through a ball-milling process. In order to control the ratio of BYN produced, the mixed powder was manufactured with a ratio of NiO:BZCYYb (0:100 to 100:0). The manufactured mixed powder was pelletized and heat-treated in a microwave sintering furnace at 1400° C. for 5 minutes to produce a NiO—BZCYYb pellet including BYN.

### 1.2 Unit Cell Production

Tape casting and screen printing techniques are used to produce the unit cell, which is sequentially composed of a fuel electrode support layer, a fuel electrode functional layer, an electrolyte layer, and an air electrode layer.

For the production of the fuel electrode support layer and functional layer tape, a slurry is composed of a NiO and BaZr_{0.4}Ce_{0.4}Y_{0.1}Yb_{0.1}O_{3-δ} (BZCYYb) composite. The electrolyte slurry includes BaZr_{0.4}Ce_{0.4}Y_{0.1}Yb_{0.1}O_{3-δ} (BZCYYb). In addition, the air electrode slurry includes BaSc_{0.1}Ta_{0.1}Co_{0.8}O_{3-δ} (BSTC).

Each prepared slurry is made into a tape using the tape casting technique, and each layer is sequentially laminated and compressed in a state of being heated to 110° C.

The tape, after the compression is completed, is heat-treated at 900° C. for 3 hours to remove organic substances remaining in each layer.

Thereafter, the NiO—BZCYYb pellet including BYN is placed in a microwave sintering furnace together with a green body after the heat treatment and sintered at 900 to 1000° C. for 5 minutes to produce a support with a double-layer structure (fuel electrode/electrolyte).

### Experimental Example

### Microstructure Analysis

A microstructure analysis was performed using scanning electron microscopy (SEM, Hitachi SU8230).

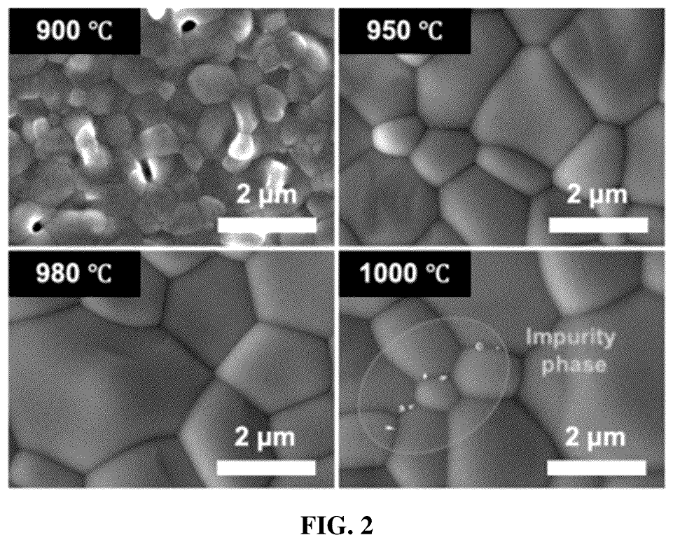

FIG. 2 is an SEM image of an electrolyte surface microstructure according to the temperature of a support manufactured according to an embodiment of the present invention.

Referring to FIG. 2, when sintering was performed at 900° C., fine pores were found on the surface; however, it was confirmed that as the temperature increased, the sintering property improved, and a similar grain size was present at 980° C. or higher. However, in the case of 1000° C., impurity phases that appeared to be insulating were observed.

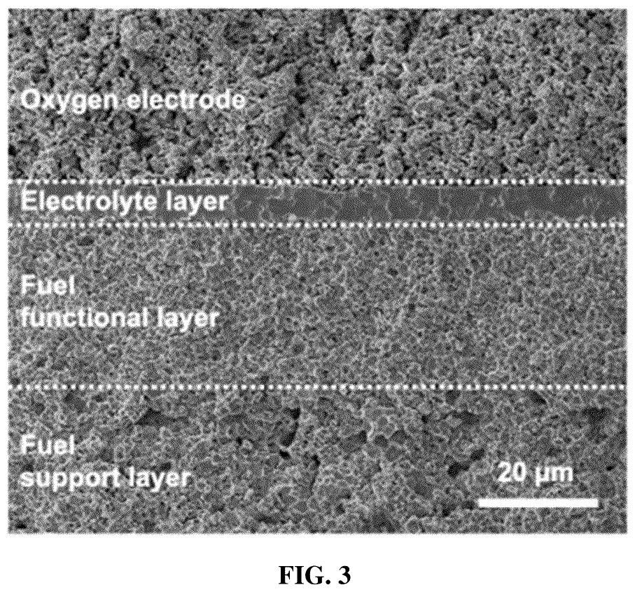

FIG. 3 is an SEM image of a microstructure of a unit cell manufactured using a support sintered at 980° C. according to an embodiment of the present invention.

Referring to FIG. 3, the unit cell is composed of a fuel electrode, an electrolyte, and an air electrode. It was confirmed that the electrolyte was sintered into a dense layer with a thickness of 6 μm and bonding was made without any peeling-off at an air electrode/electrolyte interface.

### Crystal Structure Analysis

XRD measurements of the electrolyte surface were performed using an X-ray diffractometer (RIGAKU, SmartLab) in the 20 range of 20° to 80° with Cu Kα radiation (λ=1.5418 Å). A corresponding crystal structure was refined using HighScore software.

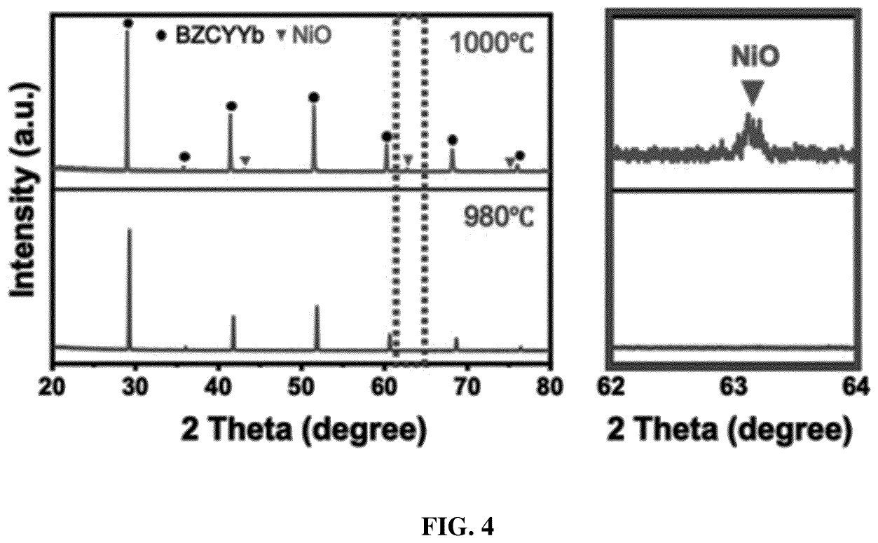

FIG. 4 is an X-ray diffraction pattern of an electrolyte of a support manufactured at 980° C. and 1000° C. according to an embodiment of the present invention.

Referring to FIG. 4, similar to the result observed in the microstructure result, it was confirmed that a NiO phase, not the complete BZCYYb phase, was found in a sample sintered at 1000° C. Therefore, it was confirmed that the 980° C. sintering condition is a condition that does not form impurities and has high sintering properties.

### Electrochemical Characteristics Evaluation

A potentiostat (Bio-Logic, VMP-300) was used to evaluate the electrochemical characteristics of a unit cell, and hydrogen (3% wet) and air (3% wet) were injected into a fuel electrode and an air electrode, respectively, during the evaluation.

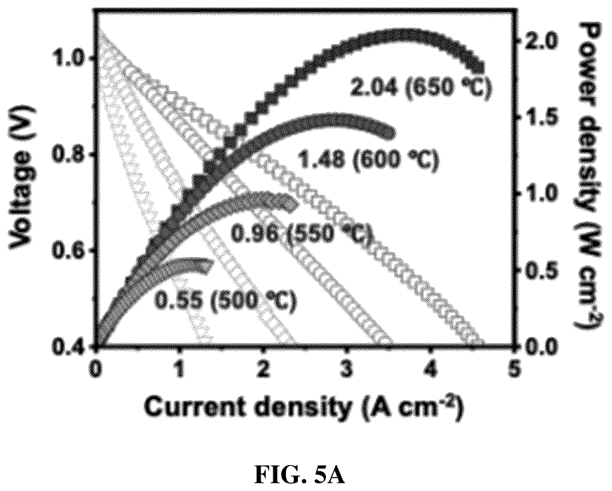

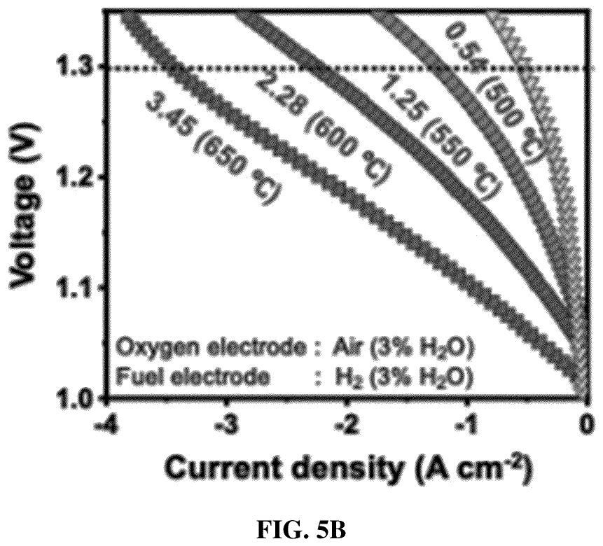

FIGS. 5A and 5B are each a graph showing the performance of a unit cell manufactured according to an embodiment of the present invention in a fuel cell (5A) or electrolytic cell (5B) mode. Referring to FIGS. 5A and 5B, in a fuel cell mode (5A), the performances were 2.04, 1.48, 0.96, and 0.55 W cm⁻² at 650° C., 600° C., 550° C., and 500° C., respectively, and in an electrolytic cell mode (5B), the performances were 3.45, 2.28, 1.25, and 0.54 A cm⁻², respectively.

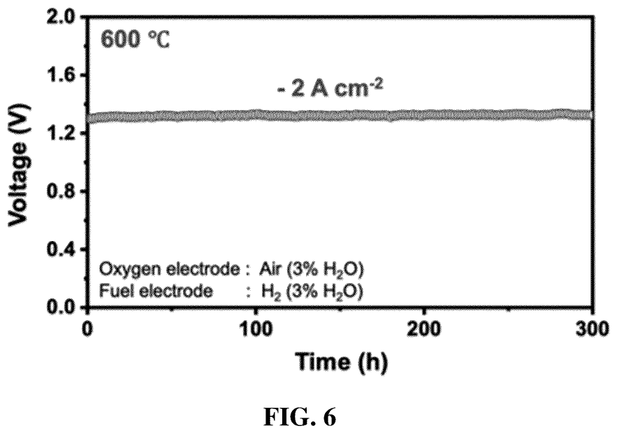

FIG. 6 is a graph showing the result of a long-term stability evaluation of a unit cell manufactured according to an embodiment of the present invention in an electrolytic cell mode.

Referring to FIG. 6, it was confirmed that the unit cell showed high stability without performance degradation under the conditions of 600° C. and −2 A cm⁻².

The description of the present invention described above is for illustrative purposes, and those skilled in the art will understand that the present invention is easily modifiable into other specific forms without changing the technical idea or essential features of the present invention. Therefore, the embodiments described above should be understood in all respects as illustrative and not restrictive. For example, each component described as single may be implemented in a distributed manner, and similarly, components described as distributed may also be implemented in a combined form.

The scope of the present invention is indicated by the claims described below, and all changes or modified forms derived from the meaning and scope of the claims and their equivalent concepts should be construed as being included in the scope of the present invention.

1. A method for manufacturing a bidirectional proton conductive fuel cell, the method comprising:
manufacturing a fuel electrode support slurry, a fuel electrode functional layer slurry, and an electrolyte slurry;
manufacturing a fuel electrode support tape, a fuel electrode functional layer tape, and an electrolyte tape by tape casting each of the fuel electrode support slurry, the fuel electrode functional layer slurry, and the electrolyte slurry;
sequentially laminating the fuel electrode support tape, the fuel electrode functional layer tape, and the electrolyte tape to form a laminated structure;
sintering the laminated structure by heat-treating in two stages;
forming an air electrode on a surface of the laminated structure where the electrolyte tape is placed; and
sintering the laminated structure in which the air electrode is formed,
wherein the sintering the laminated structure by heat-treating comprises a first heat treatment and a second heat treatment at different temperatures, and
wherein the second heat treatment includes placing a pellet that improves a sintering degree of the laminated structure in a microwave sintering furnace.

2. The method of claim 1, wherein the pellet is a NiO—BaZr0.4Ce0.4Y0.1Yb0.1O3-δ pellet.

3. The method of claim 2, wherein the NiO—BaZr0.4Ce0.4Y0.1Yb0.1O3-δ pellet is manufactured by mixing a NiO and a BaZr0.4Ce0.4Y0.1Yb0.1O3-δ into a mixed powder, pelletizing the mixed powder, and microwave sintering the mixed powder.

4. The method of claim 1, wherein the second heat treatment is performed at a temperature between 900° C. to 1000° C. for 5 to 10 minutes.

5. The method of claim 1, wherein the fuel electrode support slurry or fuel electrode functional layer slurry comprises a composite of a NiO and a BaZr0.4Ce0.4Y0.1Yb0.1O3-δ.

6. The method of claim 1, wherein the electrolyte slurry comprises BaZr0.4Ce0.4Y0.1Yb0.1O3-δ.

7. The method of claim 1, wherein, in the sequentially laminating, the fuel electrode support tape, the fuel electrode functional layer tape, and the electrolyte tape are sequentially laminated and then compressed at a temperature in a range of 100° C. to 140° C.

8. The method of claim 1, wherein the first heat treatment is performed between 800° C. and 1,000° C. for 2 to 4 hours.

9. The method of claim 1, wherein the sintering the laminated structure is performed between 800° C. and 900° C. for 2 to 5 minutes.

10. A bidirectional proton conductive fuel cell manufactured according to the method of claim 1.
